(19) United States
(12) Patent Application Publication
(10) Pub. No.: US 2025/0164039 A1
(43) Pub. Date: May 22, 2025

(54) ELASTOMER GROMMET WITH FRAGMENTED GROOVE

(71) Applicant: GM GLOBAL TECHNOLOGY OPERATIONS LLC, Detroit, MI (US)

(72) Inventor: Karthick P. Ghawalkar, Bangalore (IN)

(73) Assignee: GM GLOBAL TECHNOLOGY OPERATIONS LLC, Detroit, MI (US)

(21) Appl. No.: 18/517,030

(22) Filed: Nov. 22, 2023

(51) Int. Cl. F16L 5/02

(52) U.S. Cl. CPC F16L 5/02

(57) ABSTRACT

A grommet for securely engaging a component includes a resilient structure arranged along a longitudinal axis. The resilient structure includes an external surface defined by a grommet perimeter in a grommet front view. The grommet also includes a groove arranged on the external surface. The groove is configured to accept a portion of the component therein to facilitate retention of the grommet on the component. The grommet additionally includes at least one slit configured to fragment at least a part of the external surface via extending, in a grommet side view, into the groove. The slit(s) facilitate bending of the resilient structure at each respective slit to aid installation of the grommet into and/or removal from the component and minimize the risk of unintentional grommet push-out.

The present disclosure relates to a grommet with a fragmented groove for interfacing with a component.

A grommet is a ring or edge strip inserted into an aperture, such as a pierced hole or a U-shaped passage, in a thin section of an object. Grommets frequently include flared or collared sections to keep the grommet in place, and are made of materials such as metal, plastic, or rubber. Grommets may be used to prevent tearing or abrasion of the host object material or protection from abrasion of another object, such as insulation on a wire/cable and hydraulic tubing routed through the aperture, and/or to cover sharp edges of the aperture. Grommets may be used in such applications as aircraft, road vehicles, medical equipment, and household items.

### SUMMARY

A grommet for securely engaging a component includes a resilient structure arranged along a longitudinal axis. The resilient structure includes an external surface defined by a grommet perimeter in a grommet front view. The grommet also includes a groove arranged on the external surface. The groove is configured to accept a portion of the component therein to facilitate retention of the grommet on the component. The grommet additionally includes at least one slit configured to fragment at least a part of the external surface via extending, in a grommet side view, into the groove. The slit(s) facilitate bending of the resilient structure at each respective slit to aid installation of the grommet into and/or removal from the component and minimize the risk of unintentional grommet push-out.

The resilient structure may be constructed from an ethylene propylene diene monomer (EPDM) rubber.

The groove may extend around at least a part of the perimeter of the grommet.

The grommet may additionally include a lubricant arranged in the groove.

The external surface may include a first surface, an opposing second surface, and a third surface defining a grommet wall arranged between the first and second surfaces. In such an embodiment, the groove may be arranged on the third surface.

The grommet may include a plurality of slits. Each slit may extend across the third surface, from the first surface to the second surface. Alternatively, each slit may extend on the third surface from either the first surface or the second surface to the groove.

The resilient structure may be a molded element and the slit(s) may be molded with or into the resilient structure. Alternatively, the slit(s) may be cut into the resilient structure subsequent to molding thereof.

The slit(s) may end within the resilient structure in a rounded section to reduce the risk of tearing.

The rounded section may be either pre-molded or pierced after molding.

The slit(s) may be positioned perpendicular to the groove.

The grommet is configured to come into contact with a fluid. In such an embodiment, the grommet material may be selected based on its chemical resistance to the fluid.

The fluid may be moist air, Hydrogen gas, and/or glycol-based coolant.

An assembly including a component defining an interfacing aperture, such as a slot or a through hole and a grommet as described above configured to securely engage the component at the interfacing aperture is also considered.

Such an assembly may be a component subassembly of a motor vehicle.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic perspective view of a representative component assembly including a first component defining an interfacing aperture, a grommet engaged with the first component at the aperture, and a second component for insertion into the grommet, according to the present disclosure.

FIG. 2 is a schematic front view of the component assembly shown in FIG. 1, depicting positioning of the grommet for engagement with and disengagement from the first component, according to the disclosure.

FIG. 3 is a schematic side view of the component assembly shown in FIG. 2, specifically depicting a grommet groove with slits for engagement with and disengagement from the first component, according to the disclosure.

FIG. 4 is a schematic close-up front partial view of the grommet shown in FIGS. 1-3, specifically depicting a front view of the slits extending into the groove and fragmenting an external surface of the grommet, according to the disclosure.

FIG. 5 is a schematic side view of a non-planar embodiment of the grommet, according to the disclosure.

### DETAILED DESCRIPTION

Embodiments of the present disclosure as described herein are intended to serve as examples. Other embodiments may take various and alternative forms. Additionally, the drawings are generally schematic and not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure.

Certain terminology may be used in the following description for the purpose of reference, and thus are not intended to be limiting. For example, terms such as “above” and “below” refer to directions in the drawings to which reference is made. Terms such as “front”, “back”, “fore”, “aft”, “left”, “right”, “rear”, and “side” describe the orientation and/or location of portions of the components or elements within a consistent but arbitrary frame of reference, which is made clear by reference to the text and the associated drawings describing the components or elements under discussion. Moreover, terms such as “first”, “second”, “third”, and so on may be used to describe separate components. Such terminology may include the words specifically mentioned above, derivatives thereof, and words of similar import.

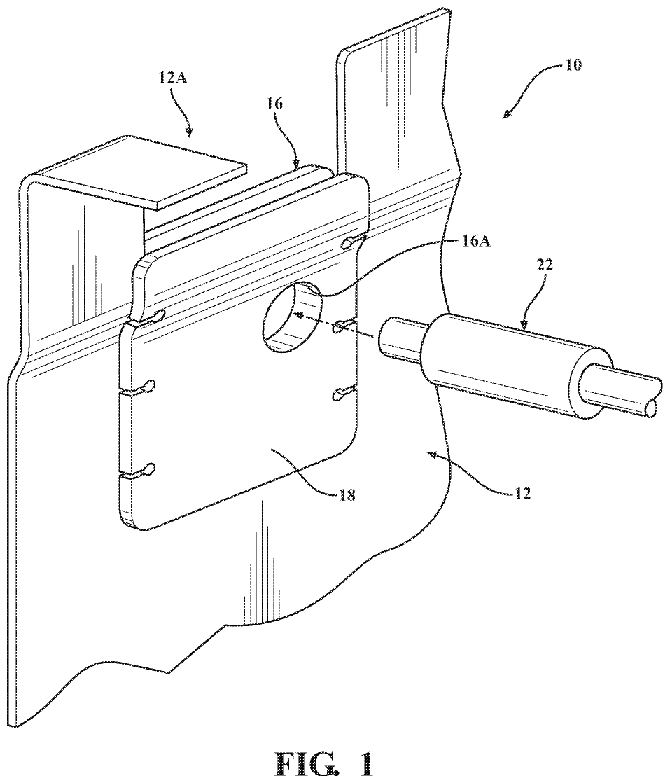

Referring to the drawings, wherein like reference numbers refer to like components, FIG. 1 shows a component assembly 10, which may be a subassembly of a motor vehicle. The component assembly 10 includes a first component 12, such as a bracket or a walled partition, defining an interfacing aperture 12A, e.g., a through hole, a slot, or another type of opening. The component assembly 10 also includes a grommet 16 configured to securely engage the component 12 at the interfacing aperture 12A. In other words, the grommet 16 is installed within the aperture 12A and thereby attached firmly relative to the first component 12. The grommet 16 includes a resilient structure 18 arranged along a longitudinal axis X.

The grommet resilient structure 18 is generally a continuous band of material which may have a generally rectangular, circular, oval, or oblong contour (shown in FIG. 2) in the grommet front view. Alternatively, the grommet 16 may have an irregular contour to match available space in the component assembly 10 and/or the shape of a particular interfacing aperture 12A. Additionally, the grommet 16 may be identified as “mono-structural”, denoting the fact that the resilient structure 18 is generated from a uniform, uninterrupted mass of a particular material without parts or sections from a different material affixed thereto.

The resilient structure 18 has an external surface 20 defined by a perimeter P in a grommet front view, shown in FIG. 2. The grommet 16 defines an aperture 16A sized to allow a second component 22 (shown in FIG. 1), such as a wire bundle, a fluid conduit, etc., to pass therethrough from one side of the first component 12 to another. The resilient structure 18 of the grommet is configured to support and protect the second component 22 during insertion thereof through the grommet and during service life of the component assembly 10. During construction of the component assembly 10, the grommet 16 may be pushed or pressed into the interfacing aperture 12A prior to the second component 22 being passed through the aperture 16A.

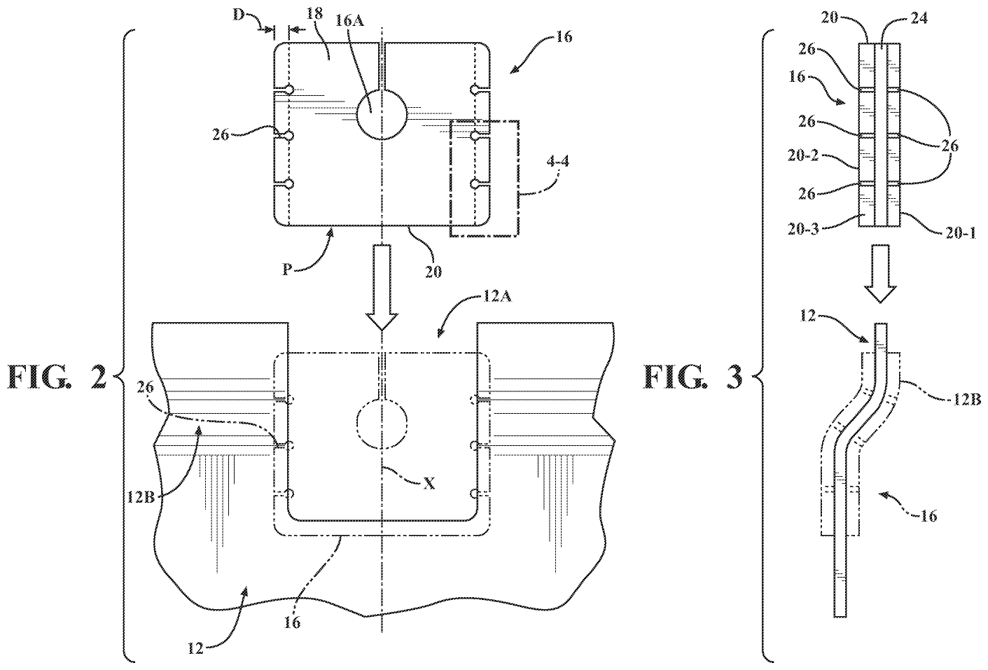

The grommet 16 also includes an interface groove 24 arranged on the external surface 20 in a grommet side view, shown in FIG. 3. The groove 24 may extend around at least a part of the perimeter P, such as a predefined portion of the perimeter, as illustrated in FIG. 3, or around the entire perimeter of the grommet 16 at a depth D (shown in FIG. 2). The external surface 20 includes a first surface 20-1, an opposing second surface 20-2, and a third surface 20-3. As shown, the third surface 20-3 defines a grommet wall arranged between the first and second surfaces 20-1, 20-2, and having sufficient thickness to generate a robust grommet structure. The groove 24 may be arranged on the third surface 20-3. The groove 24 is configured to accept at least a portion of the first component 12 therein, such as a section 12B of the subject component around the aperture 12A, to facilitate an interface with and retention of the grommet 16 on the first component.

During operational life of the component assembly 10, the grommet 16 may come into contact with various fluids. In anticipation of such an operational condition, the grommet material may be selected based on its chemical resistance to such fluids. Such fluids may be, for example, moist air, Hydrogen gas, or glycol-based coolant. Additionally, material of the grommet 16 may be selected to reliably withstand projected temperature range. For example, at the interface between the first and second components 12, 22 of a motor vehicle structure or powertrain subassembly, the temperature range may be −30 to +110 degrees Celsius. An exemplary material for the resilient structure 18 which would satisfy the above requirements is Ethylene Propylene Diene Monomer (EPDM) rubber.

The grommet 16 also includes one or more slits 26 configured to fragment the grommet wall from the third surface 20-3 to the groove 24. As a result, the resilient structure 18 is at least partially fragmented by the slits 26 in each of the grommet front view and the grommet side view. Each slit 26 may be positioned substantially perpendicular to the groove 24. The number as well as the spacing between neighboring slits 26 may be selected based on the desired magnitude of force required to remove the grommet 16 from the first component 12. The resilient structure 18 may be a molded element, such that the slit(s) 26 are pre-molded with, i.e., molded into, the structure of the grommet 16. Alternatively, the slit(s) 26 may be applied, e.g., cut, into the resilient structure 18 subsequent to molding of the grommet 16.

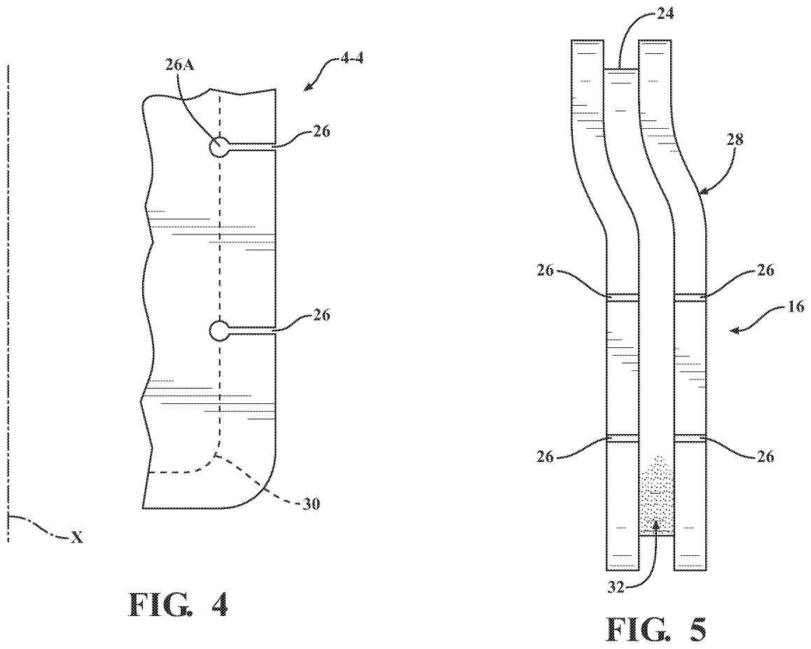

In an embodiment of the grommet 16 having a plurality of slits 26, each slit may extend across the third surface 20-3, from the first surface 20-1 to the second surface 20-2, and therefore across the groove 24, as shown in FIGS. 3 and 5. Alternatively, each slit 26 may extend over part of the third surface 20-3 from either the first surface 20-1 or from the second surface 20-2 into the groove 24 and end inside the groove (shown in FIG. 1). The slit(s) 26 may be positioned perpendicular to the groove 24. The slit(s) 26 facilitate bending of the resilient structure 18 at each respective slit to aid installation of the grommet 16 into and/or removal from the component 12 and minimize the risk of unintentional grommet push-out. Each of the slits 26 may end within the resilient structure 18 in a rounded section 26A (shown in FIG. 4). The rounded section 26A at the end of the corresponding slit is intended to reduce the risk of tearing and propagation of the subject slit in the resilient structure 18. Such rounded sections 26A may be either pre-molded, i.e., formed with the resilient structure 18, or pierced into the resilient structure after molding thereof.

As shown in FIG. 3, in the grommet side view the groove 24 may be configured to follow a contour of the first component 12. The slit(s) 26 may then additionally facilitate flexure of the resilient structure 18 and its conformance to the contour of the first component 12. The resilient structure 18 may also be characterized by an irregular or non-planar shape 28 in a side view shown in FIG. 5. The non-planar shape 28 may be specifically formed to follow the contour of the first component 12 shown in FIG. 3. As may be seen in the close-up view of the grommet's section 4-4 shown in FIG. 4, the groove 24 may further include rounded corners 30 to facilitate insertion of the grommet 16 into the first component 12. The component assembly 10 may additionally include a lubricant 32 applied into and arranged in the groove 24 to reduce friction and aid installation of the grommet 16 onto the component 12. The lubricant 32 may, for example, be a P80 water-based emulsion.

In summary, the grommet resilient structure includes slit(s) 26 extending into the interface groove 24. The slit(s) 26 are intended to fragment the grommet wall from the grommet's outer surface into the groove 24. The slit(s) 26 are thereby intended to facilitate bending of the resilient structure during installation and removal of the grommet, such as into and from a mating component. The additional bending of the grommet resilient structure also minimizes the risk of unintentional grommet push-out when the component assembly is performing its prescribed function. The slits 26 may include a stress reduction feature, such as a rounded end-section 26A to minimize the risk of tearing the resilient structure during installation and removal of the grommet.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A grommet for securely engaging a component, the grommet comprising:
a resilient structure arranged along a longitudinal axis, having an external surface defined by a grommet perimeter in a grommet front view;
a groove arranged on the external surface and configured to accept a portion of the component therein to facilitate retention of the grommet on the component; and
at least one slit configured to fragment at least a part of the external surface via extending, in a grommet side view, into the groove, thereby facilitating bending of the resilient structure at each respective slit to aid installation of the grommet into and/or removal from the component and minimize risk of unintentional grommet push-out.

2. The grommet according to claim 1, wherein the resilient structure is constructed from an ethylene propylene diene monomer (EPDM) rubber.

3. The grommet according to claim 1, wherein the groove extends around at least a part of the perimeter of the grommet.

4. The grommet according to claim 1, further comprising a lubricant arranged in the groove.

5. The grommet according to claim 1, wherein the external surface includes a first surface, an opposing second surface, and a third surface defining a grommet wall arranged between the first and second surfaces, and wherein the groove is arranged on the third surface.

6. The grommet according to claim 5, wherein the at least one slit includes a plurality of slits, and wherein each slit extends across the third surface, from the first surface to the second surface.

7. The grommet according to claim 1, wherein the resilient structure is a molded element and each slit is molded into the resilient structure.

8. The grommet according to claim 1, wherein the resilient structure is a molded element and each slit is cut into the resilient structure subsequent to molding thereof.

9. The grommet according to claim 8, wherein each slit ends within the resilient structure in a rounded section.

10. The grommet according to claim 9, wherein the rounded section is one of pre-molded and pierced after molding.

11. A component assembly comprising:
a component defining an interfacing aperture; and
a grommet configured to securely engage the component at the interfacing aperture, the grommet including:
a resilient structure arranged along a longitudinal axis, having an external surface defined by a grommet perimeter in a grommet front view;
a groove arranged on the external surface and configured to accept a portion of the component therein to facilitate retention of the grommet on the component; and
at least one slit configured to fragment at least a part of the external surface via extending, in a grommet side view, into the groove, thereby facilitating bending of the resilient structure at each respective slit to aid installation of the grommet into and/or removal from the component and minimize risk of unintentional grommet push-out.

12. The component assembly according to claim 11, wherein the resilient structure is constructed from an ethylene propylene diene monomer (EPDM) rubber.

13. The component assembly according to claim 11, wherein the groove extends around at least a part of the perimeter of the grommet.

14. The component assembly according to claim 11, further comprising a lubricant arranged in the groove.

15. The component assembly according to claim 11, wherein the external surface includes a first surface, an opposing second surface, and a third surface defining a grommet wall arranged between the first and second surfaces, and wherein the groove is arranged on the third surface.

16. The component assembly according to claim 15, wherein the at least one slit includes a plurality of slits, and wherein each slit extends across the third surface, from the first surface to the second surface.

17. The component assembly according to claim 11, wherein the resilient structure is a molded element and each slit is molded into the resilient structure.

18. The component assembly according to claim 11, wherein the resilient structure is a molded element and each slit is cut into the resilient structure subsequent to molding thereof.

19. The component assembly according to claim 18, wherein each slit ends within the resilient structure in a rounded section, and wherein the rounded section is one of pre-molded and pierced after molding.

20. A motor vehicle component subassembly comprising:
a motor vehicle component defining an interfacing aperture; and
a grommet configured to securely engage the motor vehicle component at the interfacing aperture, the grommet including:
a resilient structure arranged along a longitudinal axis, having an external surface defined by a grommet perimeter in a grommet front view;
a groove arranged on the external surface and configured to accept a portion of the motor vehicle component therein to facilitate retention of the grommet on the motor vehicle component; and
a plurality of slits configured to fragment at least a part of the external surface via extending, in a grommet side view, into the groove, thereby facilitating bending of the resilient structure at each respective slit to aid installation of the grommet into and/or removal from the motor vehicle component and minimize risk of unintentional grommet push-out;
wherein:
each slit ends within the resilient structure in a rounded section;
the rounded section is one of pre-molded and pierced after molding;
the external surface includes a first surface, an opposing second surface, and a third surface defining a resilient structure wall arranged between the first and second surfaces; and
the groove is arranged on the third surface.
